(19) United States
(12) Patent Application Publication
(10) Pub. No.: US 2017/0366571 A1
(43) Pub. Date: Dec. 21, 2017

(54) ASSET PROTECTION APPARATUS, SYSTEM AND METHOD

(71) Applicant: NTT Innovation Institute, Inc., East Palo Alto, CA (US)

(72) Inventor: Richard Boyer, East Palo Alto, CA (US)

(21) Appl. No.: 15/188,912

(22) Filed: Jun. 21, 2016

(51) Int. Cl. H04L 29/06; G06F 17/30

(52) U.S. Cl. CPC H04L 63/1433; G06F 17/30312; H04L 63/1425

(57) ABSTRACT

An asset protection system, apparatus and method are disclosed in which threat attack data that is data about a plurality of previous attacks against a plurality of targets is used to generate a threat profile for a particular threat in which the threat profile contains a threat that has a relationship to an attack mechanism that has a relationship to a victim profile based on the threat attack data. The system, apparatus and method may then protect an asset from the particular threat using the threat profile in which the asset is matched to the victim profile and a defensive response to the particular threat is identified for the asset based on the attack mechanism of the threat.

### FIELD

The disclosure relates generally to protecting an asset from a cyber-attack.

### BACKGROUND

In the world today, computers and computing resources are used extensively including smartphones, computer networks and the like. Due to the extensive use of computer and computer technologies, enterprises are being forced to allow employees to use laptops/mobile devices to connect to the enterprise network which creates a significant security threat to the enterprise and their network that may be attacked. Therefore, enterprises and their computer networks are constantly under attack from various cyber-threats from hackers and other nefarious entities (collectively “attackers”) whose goal is to exploit those security holes to steal money, steal confidential information, steal passwords and the like.

Current threat prevention systems have threat profiles that may have a known signature of a particular attack and the threat prevention system alerts the enterprise to the threat when the known signature has been identified. These current threat prevention systems however are only as good as the number of signatures that the system has identified. Thus, when a new type of threat is created by an attacker, the current threat prevention system is initially unable to protect the enterprise and its computers and network from the new threat until the signature is identified.

It would be desirable to be able to predict an attack directed to the target and implement defensive responses to mitigate the attack before the attack occurs.

### BRIEF DESCRIPTION OF THE DRAWINGS

FIG. 1 is a diagram of a set of variables associated with a cyber threat;

FIG. 2 illustrates an example of an implementation of an asset protection system that identifies a cyber treat to an asset;

FIG. 3 illustrates more details of the threat detection component of the system in FIG. 1; and

FIG. 4 illustrates a method for asset protection from cyber threats.

### DETAILED DESCRIPTION OF ONE OR MORE EMBODIMENTS

The disclosure is particularly applicable to a computer based, web services asset protection system and method and it is in this context that the disclosure will be described. It will be appreciated, however, that the asset protection system and method has greater utility since it may be implemented as a standalone computer system, an asset protection system embedded in an enterprise threat security system or implemented in other manners that are within the scope of the disclosure. In addition, the different type of threat data set forth in the description is merely illustrative and does not limit the scope of the disclosure.

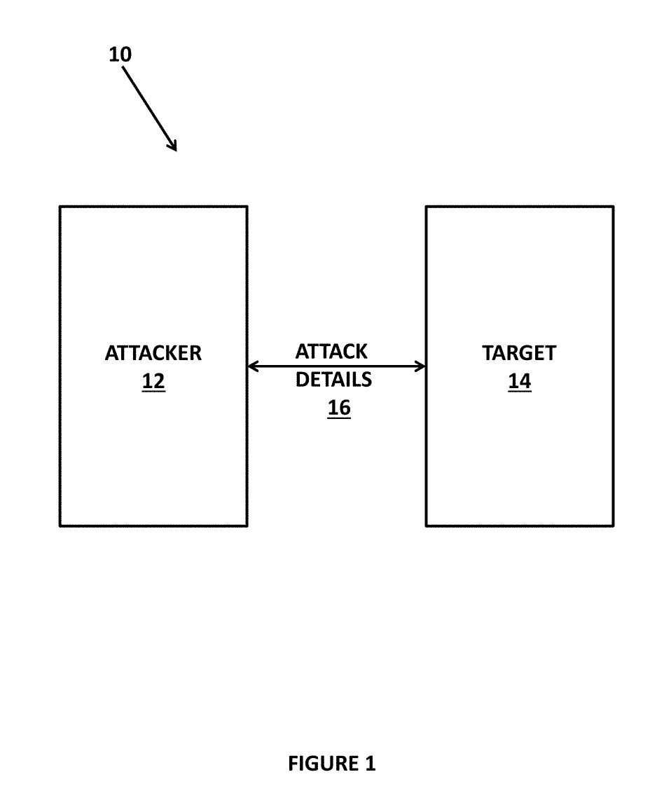

FIG. 1 is a diagram of a set of variables associated with a cyber threat 10 that may include an attacker 12, a target 14 and attack details 16. The attacker 12 may be the entity that is threatening to gain access to the network/computer network of an enterprise or other corporate entity. The attacker 12 may be an individual hacker, a botnet, a government agency and the like and another entity that is trying to access a network or other electronic resources without proper authorization. The results of the attack may be to just gain access, may be to steal information such as passwords or confidential information or may be to steal money. The target 14 may be a computer component of the enterprise or other corporate entity that is being attacked by the attacker 12 who is trying to gain access to the target. For example, the target may be a physical thing, such as a database server, an application server, a web server and/or logical assets including for example identities, personally identifiable information, financial data, access pathways into other systems, service information, credit card records, and the like since the attack may target the physical thing, but the attacker may be actually looking for logical things inside those physical things.

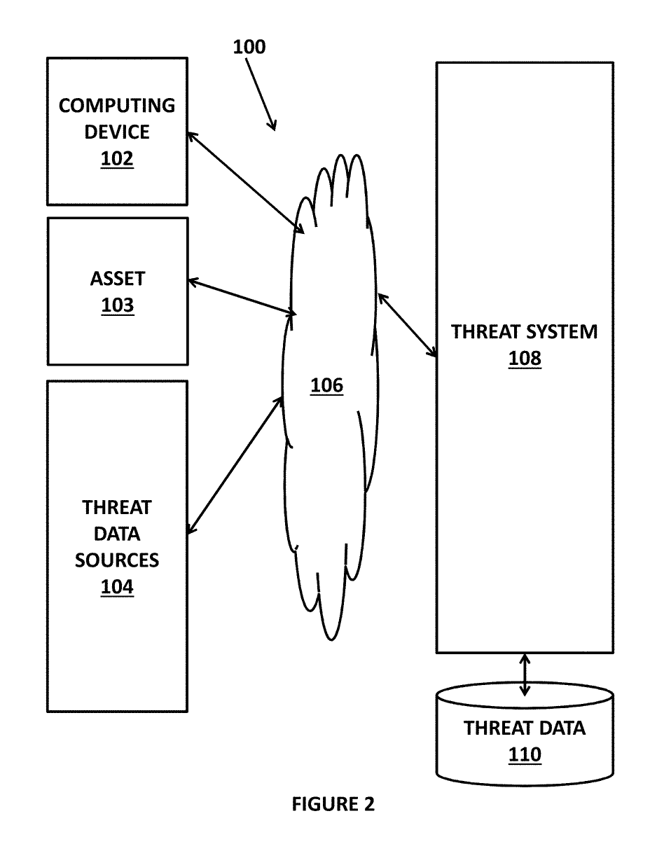

The attack details 16 are like a signature of the particular attack that contains information about the mechanism(s) used to perform the attack. In general, there is information/data available about the attacker 12, the target 14 and the attack details 16 (collectively known as threat data sources 104 in FIG. 2) that may be used to predict an attack by a particular attacker on a particular target (asset) using a particular attack detail as described below in more detail using the asset protection system and method that is now described in more detail.

FIG. 2 illustrates an example of an implementation of an asset protection system 100 that identifies a cyber treat to an asset 103 using threat data from a plurality of threat data sources 104. The asset protection system 100 may predict an attack by a particular attacker on a particular asset using particular attack details based on the threat data from a plurality of threat data sources 104. The implementation of the system 100 shown in FIG. 2 may be a web services type architecture in which an authorized user of the system may access the system using a computing device 102 to provide information to the system, such as target information for their asset and other threat data and to receive information about threats to the assets of the entity. Alternatively, the threat system 108 may be implemented as a standalone computer system, a threat system embedded in an enterprise security system and other computer architectures that are within the scope of the disclosure. Furthermore, the system may be implemented on a network routing system, a managed services system, a traffic analysis system, an embedded device system, a hardware device protection system and/or a data center analytics system.

The computing device 102 may be a processor based device with a display, memory, persistent storage and communications circuits that allow the computing device 102 to interact with a threat system 108 over a communications path 106. For example, the computing device 102 may be a smartphone device, a tablet computer, a laptop computer, a terminal device, a personal computer and the like. The computing device 102 may connect to and communicate with the threat system 108 using a typical communication and data transfer protocols.

The threat data sources 104 may be a plurality of data sources that contain data about a threat that may be used to predict an attack by a particular attacker on a particular asset using particular attack details based on the threat data. In one embodiment, the threat data may include an attacker data source containing data about known attackers, a target data source containing data about different targets (assets) and an attack details data source that contains information about known details of various different attacks. The threat data sources 104 may be resident to the threat system 108 or may be distributed from the threat system and accessed over the communication path 106 as shown in FIG. 2. The system may further have a threat data store 110 connected to the threat system 108 that may store user data and various other types of threat data.

The communication path 106 may be a wired network, a wireless network, other forms of communication or a combination of a wired and wireless network that allows the computing devices 102 to connect to, communicate with and exchange data with the threat system 108 and allows the threat system 108 to gain access to the threat data sources 104. For example, the communication path 106 may be one or more of the following: Ethernet, the Internet, an Intranet, a WiFi network, a digital data network, a cellular data network, a computer network and the like. The communication path may also include other non-traditional networks that are not based necessarily on electrical or optical transmission of data, such as any mechanism for a device to device communication such as sound based networks, tactical networks, etc. The communication path 106 may use various communication and data transfer protocols (either or both secure or insecure) so that the computing devices 102 can connect to, communicate with and exchange data with the threat system 108 and the threat system 108 can gain access to the threat data sources 104.

The threat system 108, in this implementation, may be implemented using various computing resources or cloud computing resources. The threat system 108 may receive the threat data from the threat data sources 104 and perform the analysis of the threat data as described below to generate the prediction of the threat for the particular asset and provide asset protection based on the predicted threat. The target who owns the asset may then act upon the threat prediction and prevent the threat before it occurs instead of waiting for the attack to occur and then being able to detect it by its signature as is done with typical systems.

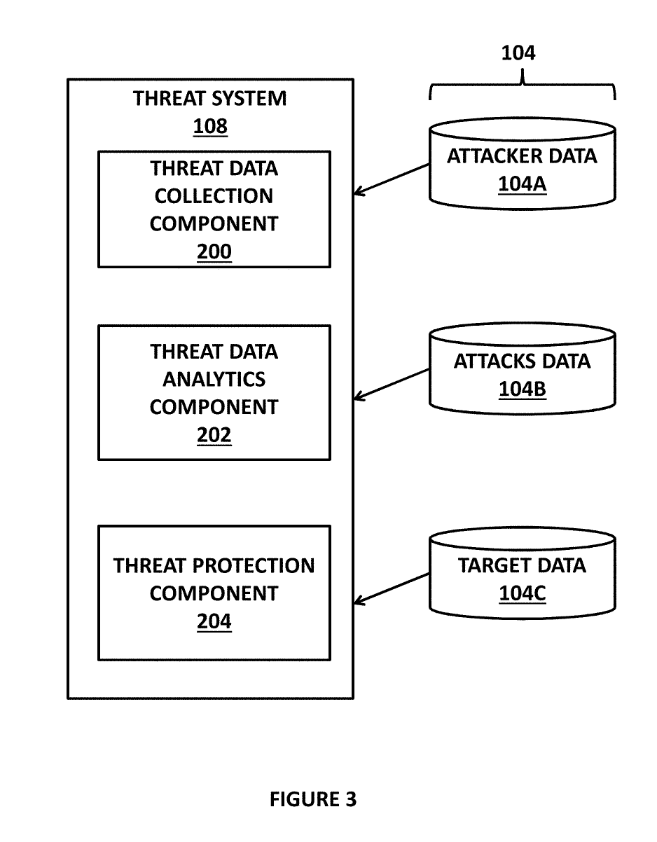

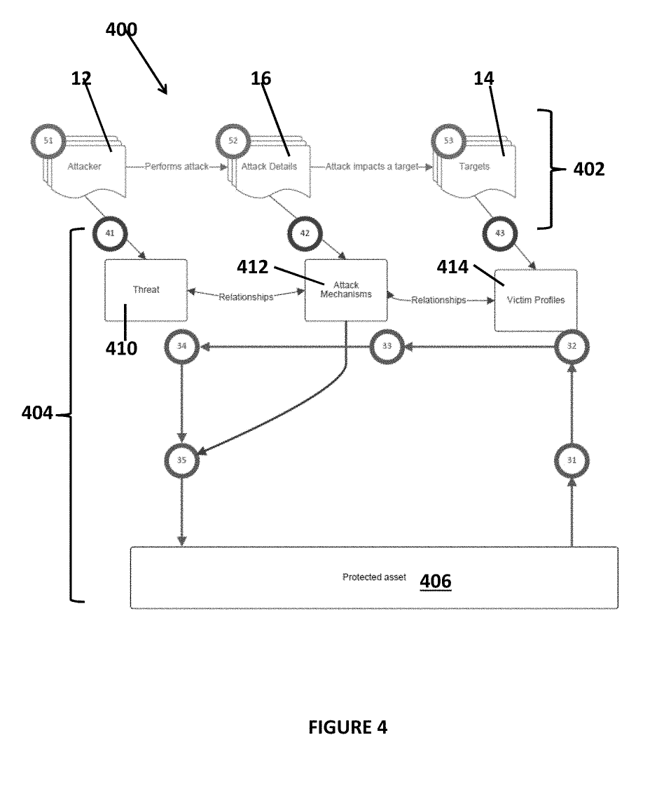

FIG. 3 illustrates more details of the threat detection component 108 of the system in FIG. 1 and FIG. 4 illustrates a method 400 for asset protection from cyber threats that may be implemented using the system shown in FIG. 3, but may also be implemented using other systems that can perform the processes shown in FIG. 4.

As shown in FIG. 3, the threat system 108 may further a threat data collection component 200, a threat data analytics component 202 and a threat protection component 204. The threat system 108 may receive/obtain attacker data 104A, attacks data 104B and target data 104C which are collectively the plurality of threat data sources 104 shown in FIG. 2. Each of the components shown in FIG. 3 may be implemented in hardware, software or a combination of hardware and software. When any of the components are implemented in software, the component may be a plurality of lines of computer code/instructions that may be stored in a memory (such as SRAM or DRAM) or persistent storage (such as flash memory or a hard disk drive) of the threat system 108 and executed by one or more processors of the threat system 108 so that the one or more processors are configured to perform the operations and functions of that component as described below. When any of the components are implemented in hardware or hardware and software, the component may be an integrated circuit, a gate array, a microcontroller, a microprocessor executing microcode or instructions and the like in which the hardware device performs the operations and functions of that component as described below.

The threat data collection component 200 obtains/collects data about the attackers 12, the attack details 16 (and the relationship to attackers) and the targets 14 from the data sources 104A-104C which is collectively data about past attacks. In some embodiments, the threat data collection component 200 may obtain the data from data sources resident in the threat system 108, in other embodiments, may obtain the data from data sources remote from the threat system 108 or in other embodiments, may obtain the data from data sources in which some of the data sources are resident in the threat system 108 and some of the data sources are remote from the threat system 108. For example, the threat data may be obtained from a number of different external source such as managed security infrastructure (e.g. the method sees it on customers devices elsewhere), from analysis of network traffic (at the internet router level) from known attack sources, acquisition from 3^{rd} party identification of attacks, collection of details from dark web and most especially by identification of those attacks by manual (by an analyst) or automated means via log records (or real time devices) as they touch systems controlled by an enterprise (security systems, network systems, web servers, etc).

As shown in FIG. 4, a data collection process 402 occurs that may be implemented using the data collection component 200 shown in FIG. 3. As shown in FIG. 4, an attacker performs an attack (that has attack details) and the attack impacts a target. For example, the attacker data (attacker collection process 51), the attack details data (the attack details collection process 52) and the target data (the target data collection process 53) for a few sample attacks may be:

Attack #1

Step 51: Attacker: 192.168.1.1

Step 51: Time: 1-January @ 10:51 AM

Step 51: Attack failed

Step 52: Attack Details: Using SSH protocol attempts unquoted search path vulnerability

Step 53: Target: 10.1.1.1 (Database Server)

Step 51: Attacker: 192.168.1.1

Step 51: Time: 1-January @ 10:52 AM

Step 51: Attack failed

Step 52: Attack Details: Using SSH protocol attempts SSH USERAUTH CHANGE REQUEST vulnerability

Step 53: Target: 10.1.1.1 (Database Server)

Step 51: Attacker: 192.168.1.1

Step 51: Time: 1-January @ 10:55 AM

Step 51: Attack failed

Step 52: Attack Details: Using SSH protocol attempts CORE SDI SSH1 CRC-32 vulnerability

Step 53: Target: 10.1.1.1 (Database Server)

Step 51: Attacker: 192.168.1.1

Step 51: Time: 1-January @ 10:59 AM

Step 51: Attack failed

Step 52: Attack Details: Using SSH protocol attempts brute force password attack

Step 53: Target: 10.1.1.1 (Database Server)

Attack #2

Step 51: Attacker: 192.168.1.1

Step 51: Time: 1-January @ 11:15 AM

Step 51: Attack successful

Step 52: Attack Details: Using SSH protocol attempts unquoted search path vulnerability

Step 53: Target: 10.1.1.2 (Web Server)

Step 51: Attacker: 192.168.1.1

Step 51: Time: 1-January @ 11:15 AM

Step 51: Attack failed

Step 52: Attack Details: Using SSH protocol attempts SSH USERAUTH CHANGE REQUEST vulnerability

Step 53: Target: 10.1.1.2 (Web Server)

Step 51: Attacker: 192.168.1.1

Step 51: Time: 1-January @ 11:17 AM

Step 51: Attack failed

Step 52: Attack Details: Using SSH protocol attempts CORE SDI SSH1 CRC-32 vulnerability

Step 53: Target: 10.1.1.2 (Web Server)

Step 51: Attacker: 192.168.1.1

Step 51: Time: 1-January @ 11:21 AM

Step 51: Attack failed

Step 52: Attack Details: Using SSH protocol attempts brute force password attack

Step 53: Target: 10.1.1.2 (Web Server)

Attack #3

Step 51: Attacker: 10.10.10.10

Step 51: Time: 7-January @ 6:29 PM

Step 51: Attack successful

Step 52: Attack Details: Performs a reconnaissance scan against all ports

Step 53: Target: 10.1.1.2 (Web Server)

Step 51: Attacker: 10.10.10.10

Step 51: Time: 7-January @ 6:29 PM

Step 51: Attack failed

Step 52: Attack Details: Using SSH protocol attempts brute force password attack

Step 53: Target: 10.1.1.2 (Web Server)

Step 51: Attacker: 10.10.10.10

Step 51: Time: 8-January @ 7:30 PM

Step 51: Attack failed

Step 52: Attack Details: Using telnet protocol attempts brute force password attack

Step 53: Target: 10.1.1.2 (Web Server)

Step 51: Attacker: 10.10.10.10

Step 51: Time: 9-January @ 1:06 PM

Step 51: Attack successful

Step 52: Attack Details: Using HTTP protocol attempts brute force password attack against login page

Step 53: Target: 10.1.1.2 (Web Server)

Step 51: Attacker: 10.10.10.10

Step 51: Time: 9-January @ 1:10 PM

Step 51: Attack failure

Step 52: Attack Details: Using user account attempt privilege escalation.

Step 53: Target: 10.1.1.2 (Web Server)

In these examples, the attacker data may include an internet protocol (IP address) of the attacker, a time of the attack and the status (success or failure) of the attack. The attack details describe how the attack was carried out and the target data contains the IP address of the target component like the database server or the web server in the above examples.

Returning to FIG. 3, the threat data analytics component 202 may perform several processes including a threat data aggregation process and a threat data analysis process. The threat data analytics component 202 may be used, in some embodiments, to perform the processes 410-414 and processes 31-43 as shown in FIG. 4 in which derivative knowledge about the threats are determined through aggregation and analytics. The processes 410-414 may be a threat process 410 (aggregation process 41) in which attack data is aggregated with a summary analytic per each threat so that the data on one attacking resource (what they did, who they are, how they went about it, when the did it) is aggregated and each one of these resources and the aggregate knowledge of that attacker collectively becomes a threat. The processes may include an attack mechanism process 412 (aggregation process 42) that generates a summary analysis of each type of attack. The aggregated data on each attack mechanism may include how the attack was carried out, what were the mechanisms, the patterns of attack) and each one of these collective knowledge of how an attack works becomes an attack mechanism. This process maintains relationships between threats and attack mechanisms in both directions.

The processes may also include a victim profile process 414 (aggregation process 43) that aggregates and analyzes the target data to profile victims. The process may thus aggregate data on each target (how they were attacked, when it happened, patterns, weaknesses, exploitation, vulnerabilities, timelines, industry information, geographic details, line of businesses, etc.) and this aggregated data tells the story of how the mechanics that lead to the attack working and why it was a target, thus creating a profile of a victim. In this aggregated victim profile data, the relationships between attack mechanisms and victim profiles are maintained in both directions. For example, the various aggregated data (based on the example threat data above) from the processes 401-414 for a few sample threats may be:

Threat Aggregation (Process 41)

Threat: 192.168.1.1

Attack Timing: Delivery stage attack 2 times, lasting 4-6 minutes

Attack analytics: Blind attack without prior reconnaissance, information gathering no escalation

Attack Targets: SSH

Attack Vulnerabilities: SSH search path vulnerabilities, Userauth Change Request vulnerabilities, CORE SI vulnerabilities and brute force

Attacks Types Used: Attack Type ID 1

Victim Relationship Identifier: 10.1.1.2, 192.168.1.1

Threat: 10.10.10.10

Attack Timing: Reconnaissance stage attack 1 times, last 10 minutes; delivery stage attack against multiple services (SSH, TELNET, HTTP), exploitation stage attack against HTTP

Attack analytics: Attack escalation based on success

Attack Targets: All Ports (Reconnaissance), found ports (SSH, TELNET, HTTP)

Attack Vulnerabilities: Port scanning, brute force and escalation

Attacks Types Used: Attack Type ID 2

Victim Relationship Identifier: 10.1.1.2

Attack Aggregation (Process 42)

Attack Type ID: 1

Attack Details: Blind SSH Attacks

Vulnerabilities Attempted: SSH Unquoted Search Path, USERAUTH CHANGE REQUEST, CORE SDI

Enumerations Attempted: Brute Force

Attack Sequence: 1) Unquoted Search Path, 2) USERAUTH CHANGE REQUEST, 3) CORE SDI 4) Brute force

Cyber Kill Chain: 3-3-3-3

Actions on Success: None (likely information gathering only)

Attack Timing: Attacks occur over several minutes

Attack Type ID: 2

Attack Details: Automated Attack Escalation

Vulnerabilities Attempted: Port Scan, HTTP privilege escalation

Enumerations Attempted: SSH Brute Force, Telnet Brute Force, HTTP Brute Force,

Attack Sequence: 1) Port Scan 2) Brute Force (multiple ports) 3 Privilege Escalation

Cyber Kill Chain: 1-3-4

Actions on Success: Escalation (Kill Chain order with hidden steps)

Attack Timing: Attacks occur over large period of time (days)

Victim Profile (process 43)

Victim: 10.1.1.2

Server Type: Web Server

Attacked: 7 times

Ports Targeted: all (port scan), SSH, Telnet, HTTP

Vulnerabilities targeted: SSH Brute Force, Telnet Brute Force, HTTP Password Brute Force

Number of attackers: 2

Attacker Relationship Identifier: 10.10.10.10, 192.168.1.1

Attack Types Used: Attack Type ID: 1, Attack Type ID: 2

Attacks Succeeded: HTTP Password Brute Force

Victim: 10.1.1.1

Server Type: Database Server

Attacked: 4 times

Ports Targeted: SSH

Vulnerabilities targeted: SSH Brute Force, SSH Unquoted Search Path, USERAUTH CHANGE REQUEST, CORE SDI

Number of attackers: 1

Attacker Relationship Identifier: 192.168.1.1

Attack Types Used: Attack Type ID: 1 Attacks Succeeded: None

Returning to FIG. 3, the threat protection component 204 may perform several analytics processes about the threat data and may utilize the threat data store 110 of the threat system 108. The threat protection component 204 may be used, in some embodiments, to perform the processes 31-35 as shown in FIG. 4.

Build a Profile Process

As shown in FIG. 4, process 31 may build a profile of a protected asset for a particular user of the system such as an enterprise or company. For example, a profile for a protected asset based on the sample data above may be:

Asset: 10.20.30.40

Server Type: Database server

Services Running: SSH, Telnet

Known Vulnerabilities: SSH Unquoted Search Path

Matching Process

Process 32 may determine if the asset profile matches against any known victims (partial or full matches) based on the victim profiles generated by the processes described above. For example, the matching may be performed based on direct and indirect data. Direct data is things like IP address, domain, URL, hash. Indirect data is derived data such as CIDR block for the IP addresses, what network they come from, which Anonymous System Number (ASN) they belong to, what industry they are associated with, what geography, attribution to a particular hacker group. The algorithm is based on closeness of direct and indirect things describing the victim and the asset in common (or percent in common). The more things in common, the more likely to be targeted. In one implementation, machine learning may be used to determine likelihood against a whole range of weighted factors. For example, based on the sample data above, the results of this process may be:

Asset: 10.20.30.40

Victim Profile Matches: 10.1.1.1
Database Server=Match
SSH Port=Match
Vulnerability=Match

Match Alignment: 75%

Victim Profile Matches: 10.1.1.2
SSH Port=Match
Telnet=Match

Match Alignment: 35%

In some embodiments, the match percentage may be 75%-above 95%. In some embodiments, a match percentage of 75% may be used, although the match percentage may be selected by each user/customer of the system who can set the match percentage at more than 95% in some cases.

Determine Attack Aggregation Process

Process 33 may determine relevant attacks mechanism that may be used against those victims based on the relationship between victim profiles and attack mechanisms. For example, based on the sample data above, the results of this process may be:

Asset: 10.20.30.40

Victim Profile Matches: 10.1.1.1

Related Attack Aggregation: Attack Type ID: 1

Victim Profile Matches: 10.1.1.2

Related Attack Aggregation: Attack Type ID: 2

Determine Attackers Process

Process 34 may then determine relevant threats based on the relationship between attack types and the threats. For example, based on the sample data above, the results of this process may be:

Asset: 10.20.30.40

Victim Profile Matches: 10.1.1.1

Related Attack Aggregation: Attack Type ID: 1

Therefore: 192.168.1.1 (attacker)

Remediation: Block 192.168.1.1 using firewall (SSH port)

Victim Profile Matches: 10.1.1.2

Related Attack Aggregation: Attack Type ID: 2

Therefore: 10.10.10.10 (attacker)

Remediation: Block 10.1.1.2 using firewall (SSH and Telnet ports), Block 10.1.1.2 using web server ACL list (HTTP ports)

Determine Protections Process

Process 35 may look up defensive responses based on the attack mechanism and apply the defensive response based on the threat to the asset. For example, based on the sample data above, the results of this process may be:

Attack Type ID: 1 and Attack Type ID: 2

Vulnerability: SSH Brute Force
Apply patch for SSH Brute Force (based on software version)

Vulnerability: Telnet Brute Force
Apply patch for Telnet Brute Force (based on software version)

Vulnerability: HTTP Brute Force
Apply patch for HTTP Login Brute Force (based on software version)

Vulnerability: HTTP escalation
Based on HTTP software version apply patch for HTTP escalation attacks

Thus, the asset protection system, based on the aggregated threat data and analytics, is able to predict a threat that may be directed at the asset and implement the defensive responses to address the potential threat before it occurs.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that performs particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The above disclosed system, apparatus and method protects an asset (a computer network, any computer network, an entity, a residence, an enterprise network, etc.) from a hacking threat in which a threat profile may be used in which the asset is matched to the victim profile and a defensive response to the particular threat is identified for the asset based on the attack mechanism of the threat. The disclosed system, apparatus and method is in the technology or technical field of cyber threat identification and asset protection. Typical threat system may match a threat to a known signature of a threat (most firewalls operate in this manner or virus scanning software) in order to thwart that threat. However, these systems are static in that they will protect only against a threat whose signature is known and part of the firewall or software system. In contrast the disclosed system, apparatus and method improves the technical field of cyber threat identification and asset protection by using a threat profile and the asset being protected is matched to the victim profile and a defensive response to the particular threat is identified for the asset based on the attack mechanism of the threat which does not exist with any current cyber threat identification and asset protection system and methods.

The above disclosed system, method and apparatus is also solving a problem (cyber threats) which did not exist prior to the Internet and computer networks. Thus, the system, method and apparatus do not recite a mathematical algorithm; nor does it recite a fundamental economic or longstanding commercial practice. The above disclosed system, method and apparatus address a business challenge (protecting an asset against cyber threats over a computer network) that is particular to the Internet and thus computer networks. The above disclosed system, method and apparatus does not “merely recite the performance of some business practice known from the pre-Internet world along with the requirement to perform it on the Internet.” Instead, the above disclosed system, method and apparatus is necessarily rooted in computer technology in order to overcome a problem specifically arising in the realm of computer networks.” Thus, the above disclosed system, method and apparatus is directed to statutory subject matter.

The above disclosed system, method and apparatus may be implemented on a computer system, server computer, networked appliance and the like (a particular machine) that performs the functions and operations of the above disclosed system, method and apparatus. Although the particular machine may be a known hardware computing resource, the particular machine and the technology of the above disclosed system, method and apparatus makes that machine more than a generic computer since the machine is a computing resource specially designed to protect an asset from cyber threats. Furthermore, the machine of the above disclosed system, method and apparatus is not simply performing generic computer functions since the processes performed by the above disclosed system, method and apparatus are substantially more than generic computer functions. Specifically, the machine may perform the processes of obtaining threat attack data, the threat attack data being data about a plurality of previous attacks against a plurality of targets, generating a threat profile for a particular threat using the threat attack data, the threat profile containing a threat that has a relationship to an attack mechanism that has a relationship to a victim profile based on the threat attack data and protecting an asset from the particular threat using the threat profile in which the asset is matched to the victim profile and a defensive response to the particular threat is identified for the asset based on the attack mechanism of the threat which are not generic computer functions.

The above disclosed system, method and apparatus may also receive data about a threat including attacker data, attack details data and threat target data and, using that data, protect an asset from a threat by identifying a defensive response to the particular threat for the asset based on the attack mechanism of the threat. The disclosed system, method and apparatus thus transform the plurality of pieces of data about the attacker, the attack details and the threat target data (an article) into a different state (the identified defensive response to the threat).

The above disclosed system, method and apparatus also has processes (set forth in the claims) that are other than those well understood, routine and known in the art. In particular, unlike the typical systems, the system uses the data about the attacker, the attack details and the threat target data to protect an asset from the particular threat using the threat profile in which the asset is matched to the victim profile and a defensive response to the particular threat is identified for the asset based on the attack mechanism of the threat which is not well understood, routine or known in the art since none of the known threat protection systems and methods employ the combination of the above processes of the above disclosed system, method and apparatus.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method for asset threat protection, comprising:
obtaining threat attack data, the threat attack data being data about a plurality of previous attacks against a plurality of targets;
generating a threat profile for a particular threat using the threat attack data, the threat profile containing a threat that has a relationship to an attack mechanism that has a relationship to a victim profile based on the threat attack data; and
protecting an asset from the particular threat using the threat profile in which the asset is matched to the victim profile and a defensive response to the particular threat is identified for the asset based on the attack mechanism of the threat.

2. The method of claim 1, wherein generating the threat profile further comprises performing analytics using the threat attack data to generate the threat profile.

3. The method of claim 1, wherein the threat attack data further comprises data about each attacker that launches a threat, data about previous threat attacks and a relationship of the previous attack to an attacker and data about a target of the previous threat attacks.

4. The method of claim 3, wherein generating the threat profile further comprises performing analytics using the data about each attacker, data about previous threat attacks and data about the targets of the previous threat attacks.

5. An apparatus for asset threat protection, comprising:
a processor having a plurality of lines of computer code that are executed by the processor so that the processor is configured to:
obtain threat attack data, the threat attack data being data about a plurality of previous attacks against a plurality of targets;
generate a threat profile for a particular threat using the threat attack data, the threat profile containing a threat that has a relationship to an attack mechanism that has a relationship to a victim profile based on the threat attack data; and
protect an asset from the particular threat using the threat profile in which the asset is matched to the victim profile and a defensive response to the particular threat is identified for the asset based on the attack mechanism of the threat.

6. The apparatus of claim 5, wherein the processor is further configured to perform analytics using the threat attack data to generate the threat profile.

7. The apparatus of claim 5, wherein the threat attack data further comprises data about each attacker that launches a threat, data about previous threat attacks and a relationship of the previous attack to an attacker and data about a target of the previous threat attacks.

8. The apparatus of claim 7, wherein the processor is further configured to perform analytics using the data about each attacker, data about previous threat attacks and data about the targets of the previous threat attacks.
